(19) United States
(12) Patent Application Publication
(10) Pub. No.: US 2026/0073189 A1
(43) Pub. Date: Mar. 12, 2026

(54) GENERATING MULTI-TASK FRAME PREDICTIONS

(71) Applicant: DIGITAL SURGERY LIMITED, London (GB)

(72) Inventors: Haodi Weng, London (GB); Felix John Samuel Bragman, London (GB); Danail V. Stoyanov, London (GB); Imanol LuengoMuntion, Bilbao (ES)

(21) Appl. No.: 19/321,675

(22) Filed: Sep. 8, 2025

Related U.S. Application Data
(60) Provisional application No. 63/692,486, filed on Sep. 9, 2024.

(51) Int. Cl. G06N 3/045; G06N 3/0499

(52) U.S. Cl. CPC G06N 3/045; G06N 3/0499

(57) ABSTRACT

Examples described herein provide a computer-implemented method for generating multi-task frame predictions for a current frame of a video of a surgical procedure. The method includes receiving historical video frames. The method further includes generating a plurality of multi-task prompts based on the historical video frames. The method further includes generating a plurality of spatial temporal embeddings based on the historical video frames and a current video frame. The method further includes generating multi-task frame predictions based on the plurality of multi-task prompts and the plurality of spatial temporal embeddings.

### CROSS-REFERENCE TO RELATED APPLICATIONS

This application claims the benefit of U.S. Patent Application No. 63/692,486, filed Sep. 9, 2024, the contents of which are incorporated by reference herein in their entirety.

### BACKGROUND

The present disclosure relates in general to computing technology and relates more particularly to computing technology for generating multi-task frame predictions, such as for a current frame of a video of a surgical procedure.

Computer-assisted systems, particularly computer-assisted surgery systems (CASs), rely on video data digitally captured during a surgery. Such video data can be stored and/or streamed. In some cases, the video data can be used to augment a person's physical sensing, perception, and reaction capabilities. For example, such systems can effectively provide the information corresponding to an expanded field of vision, both temporal and spatial, that enables a person to adjust current and future actions based on the part of an environment not included in his or her physical field of view. Alternatively, or in addition, the video data can be stored and/or transmitted for several purposes such as archival, training, post-surgery analysis, and/or patient consultation.

### SUMMARY

According to an aspect, a computer-implemented method for generating multi-task frame predictions for a current frame of a video of a surgical procedure is provided. The method includes receiving historical video frames. The method further includes generating a plurality of multi-task prompts based on the historical video frames. The method further includes generating a plurality of spatial temporal embeddings based on the historical video frames and a current video frame. The method further includes generating multi-task frame predictions based on the plurality of multi-task prompts and the plurality of spatial temporal embeddings.

### BRIEF DESCRIPTION OF THE DRAWINGS

The specifics of the exclusive rights described herein are particularly pointed out and distinctly claimed in the claims at the conclusion of the specification. The foregoing and other features and advantages of the aspects of the aspects described herein are apparent from the following detailed description taken in conjunction with the accompanying drawings in which:

FIG. 1 depicts a computer-assisted surgery (CAS) system according to one or more aspects described herein;

FIG. 2 depicts a surgical procedure system according to one or more aspects described herein;

FIG. 3 depicts a system for analyzing video captured by a video recording system according to one or more aspects described herein;

FIG. 4 depicts a network that incorporates a multi-task prompt learning model according to one or more aspects described herein;

FIG. 5 depicts the model of FIG. 4 according to one or more aspects described herein;

FIG. 6 depicts an architecture for performing multi-task prompt prediction, processing a current frame in a video feed, and generating multi-task frame predictions, according to one or more aspects described herein;

FIG. 7A depicts aspects of a cross-task prompt network according to one or more aspects described herein;

FIG. 7B depicts aspects of a prompt refinement decoder head according to one or more aspects described herein;

FIG. 8 depicts a flow diagram of a method according to one or more aspects described herein;

FIG. 9 depicts a block diagram of a computer system according to one or more aspects described herein;

FIGS. 10A and 10B together depict selected results according to one or more aspects described herein;

FIG. 11 depicts example phase prediction results according to one or more aspects described herein; and

FIG. 12 depicts example tool prediction results according to one or more aspects described herein.

The diagrams depicted herein are illustrative. There can be many variations to the diagrams and/or the operations described herein without departing from the scope of the aspects. For instance, the actions can be performed in a differing order, or actions can be added, deleted, or modified. Also, the term “coupled” and variations thereof describe having a communications path between two elements and do not imply a direct connection between the elements with no intervening elements/connections between them. All of these variations are considered a part of the specification.

### DETAILED DESCRIPTION

Computer vision applications applied to videos, such as object tracking and instance segmentation, often utilize temporal networks. Such approaches are computationally expensive and, as such, are not suitable for real-time use.

One or more aspects described herein provide for generating multi-task frame predictions for a current frame of a surgical procedure.

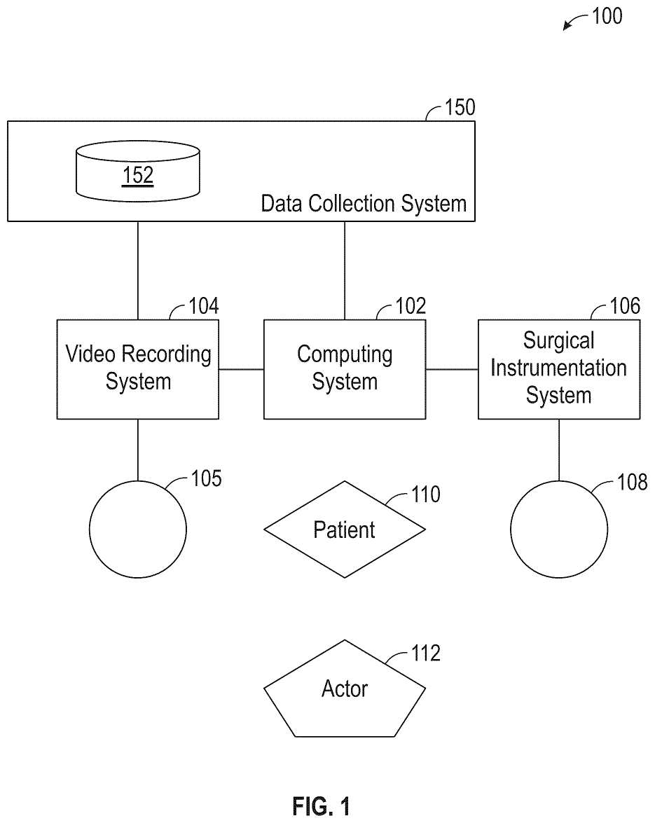

Turning now to FIG. 1, an example computer-assisted system (CAS) system 100 is generally shown in accordance with one or more aspects. The CAS system 100 includes at least a computing system 102, a video recording system 104, and a surgical instrumentation system 106. As illustrated in FIG. 1, an actor 112 can be medical personnel that uses the CAS system 100 to perform a surgical procedure on a patient 110. Medical personnel can be a surgeon, assistant, nurse, administrator, or any other actor that interacts with the CAS system 100 in a surgical environment. The surgical procedure can be any type of surgery, such as but not limited to cataract surgery, laparoscopic cholecystectomy, endoscopic endonasal transsphenoidal approach (eTSA) to resection of pituitary adenomas, or any other surgical procedure. In other examples, actor 112 can be a technician, an administrator, an engineer, or any other such personnel that interacts with the CAS system 100. For example, actor 112 can record data from the CAS system 100, configure/update one or more attributes of the CAS system 100, review past performance of the CAS system 100, repair the CAS system 100, and/or the like including combinations and/or multiples thereof.

A surgical procedure can include multiple phases, and each phase can include one or more surgical actions. A “surgical action” can include an incision, a compression, a stapling, a clipping, a suturing, a cauterization, a sealing, or any other such actions performed to complete a phase in the surgical procedure. A “phase” represents a surgical event that is composed of a series of steps (e.g., closure). A “step” refers to the completion of a named surgical objective (e.g., hemostasis). During each step, certain surgical instruments 108 (e.g., forceps) are used to achieve a specific objective by performing one or more surgical actions. In addition, a particular anatomical structure of the patient may be the target of the surgical action(s).

The video recording system 104 includes one or more cameras 105, such as operating room cameras, endoscopic cameras, and/or the like including combinations and/or multiples thereof. The cameras 105 capture video data of the surgical procedure being performed. The video recording system 104 includes one or more video capture devices that can include cameras 105 placed in the surgical room to capture events surrounding (i.e., outside) the patient being operated upon. The video recording system 104 further includes cameras 105 that are passed inside (e.g., endoscopic cameras) the patient 110 to capture endoscopic data. The endoscopic data provides video and images of the surgical procedure.

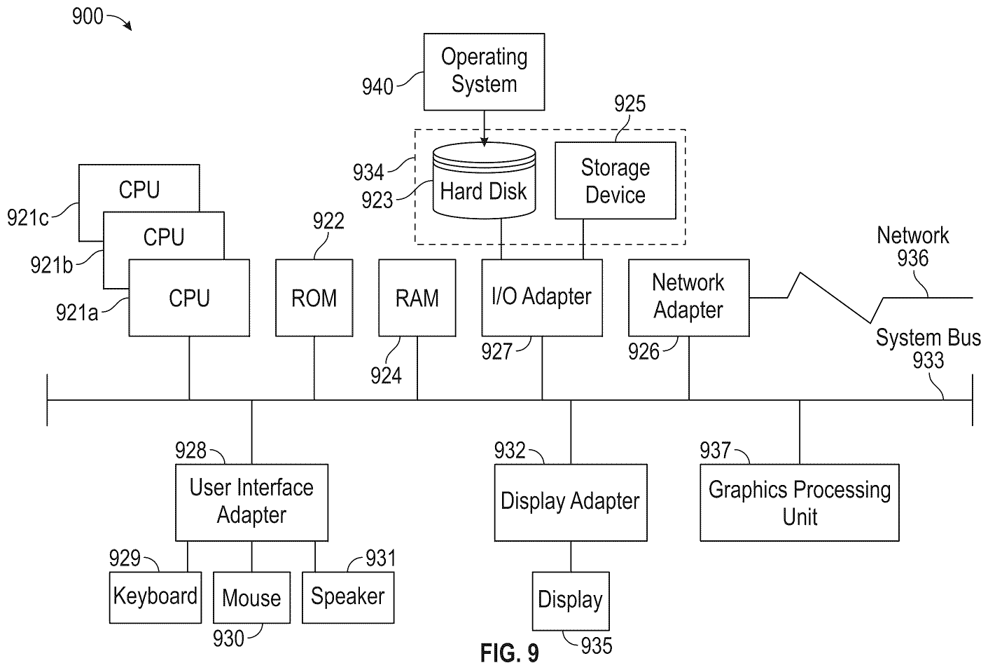

The computing system 102 includes one or more memory devices, one or more processors, a user interface device, among other components. All or a portion of the computing system 102 shown in FIG. 1 can be implemented for example, by all or a portion of computer system 900 of FIG. 9. Computing system 102 can execute one or more computer-executable instructions. The execution of the instructions facilitates the computing system 102 to perform one or more methods, including those described herein. The computing system 102 can communicate with other computing systems via a wired and/or a wireless network. In one or more examples, the computing system 102 includes one or more trained machine learning models that can detect and/or predict features of/from the surgical procedure that is being performed or has been performed earlier. Features can include structures, such as anatomical structures, surgical instruments 108 in the captured video of the surgical procedure. Features can further include events, such as phases and/or actions in the surgical procedure. Features that are detected can further include the actor 112 and/or patient 110. Based on the detection, the computing system 102, in one or more examples, can provide recommendations for subsequent actions to be taken by the actor 112. Alternatively, or in addition, the computing system 102 can provide one or more reports based on the detections. The detections by the machine learning models can be performed in an autonomous or semi-autonomous manner.

The machine learning models can include artificial neural networks, such as deep neural networks, convolutional neural networks, recurrent neural networks, vision transformers, encoders, decoders, or any other type of machine learning model. The machine learning models can be trained in a supervised, unsupervised, or hybrid manner. The machine learning models can be trained to perform detection and/or prediction using one or more types of data acquired by the CAS system 100. For example, the machine learning models can use the video data captured via the video recording system 104. Alternatively, or in addition, the machine learning models use the surgical instrumentation data from the surgical instrumentation system 106. In yet other examples, the machine learning models use a combination of video data and surgical instrumentation data.

Additionally, in some examples, the machine learning models can also use audio data captured during the surgical procedure. The audio data can include sounds emitted by the surgical instrumentation system 106 while activating one or more surgical instruments 108. Alternatively, or in addition, the audio data can include voice commands, snippets, or dialog from one or more actors 112. The audio data can further include sounds made by the surgical instruments 108 during their use.

In one or more examples, the machine learning models can detect surgical actions, surgical phases, anatomical structures, surgical instruments, and various other features from the data associated with a surgical procedure. The detection can be performed in real-time in some examples. Alternatively, or in addition, the computing system 102 analyzes the surgical data, i.e., the various types of data captured during the surgical procedure, in an offline manner (e.g., post-surgery). In one or more examples, the machine learning models detect surgical phases based on detecting some of the features, such as the anatomical structure, surgical instruments, and/or the like including combinations and/or multiples thereof.

A data collection system 150 can be employed to store the surgical data, including the video(s) captured during the surgical procedures. The data collection system 150 includes one or more storage devices 152. The data collection system 150 can be a local storage system, a cloud-based storage system, or a combination thereof. Further, the data collection system 150 can use any type of cloud-based storage architecture, for example, public cloud, private cloud, hybrid cloud, and/or the like including combinations and/or multiples thereof. In some examples, the data collection system can use a distributed storage, i.e., the storage devices 152 are located at different geographic locations. The storage devices 152 can include any type of electronic data storage media used for recording machine-readable data, such as semiconductor-based, magnetic-based, optical-based storage media, and/or the like including combinations and/or multiples thereof. For example, the data storage media can include flash-based solid-state drives (SSDs), magnetic-based hard disk drives, magnetic tape, optical discs, and/or the like including combinations and/or multiples thereof.

In one or more examples, the data collection system 150 can be part of the video recording system 104, or vice-versa. In some examples, the data collection system 150, the video recording system 104, and the computing system 102, can communicate with each other via a communication network, which can be wired, wireless, or a combination thereof. The communication between the systems can include the transfer of data (e.g., video data, instrumentation data, and/or the like including combinations and/or multiples thereof), data manipulation commands (e.g., browse, copy, paste, move, delete, create, compress, and/or the like including combinations and/or multiples thereof), data manipulation results, and/or the like including combinations and/or multiples thereof. In one or more examples, the computing system 102 can manipulate the data already stored/being stored in the data collection system 150 based on outputs from the one or more machine learning models (e.g., phase detection, anatomical structure detection, surgical tool detection, and/or the like including combinations and/or multiples thereof). Alternatively, or in addition, the computing system 102 can manipulate the data already stored/being stored in the data collection system 150 based on information from the surgical instrumentation system 106.

In one or more examples, the video captured by the video recording system 104 is stored on the data collection system 150. In some examples, the computing system 102 curates parts of the video data being stored on the data collection system 150. In some examples, the computing system 102 filters the video captured by the video recording system 104 before it is stored on the data collection system 150. Alternatively, or in addition, the computing system 102 filters the video captured by the video recording system 104 after it is stored on the data collection system 150.

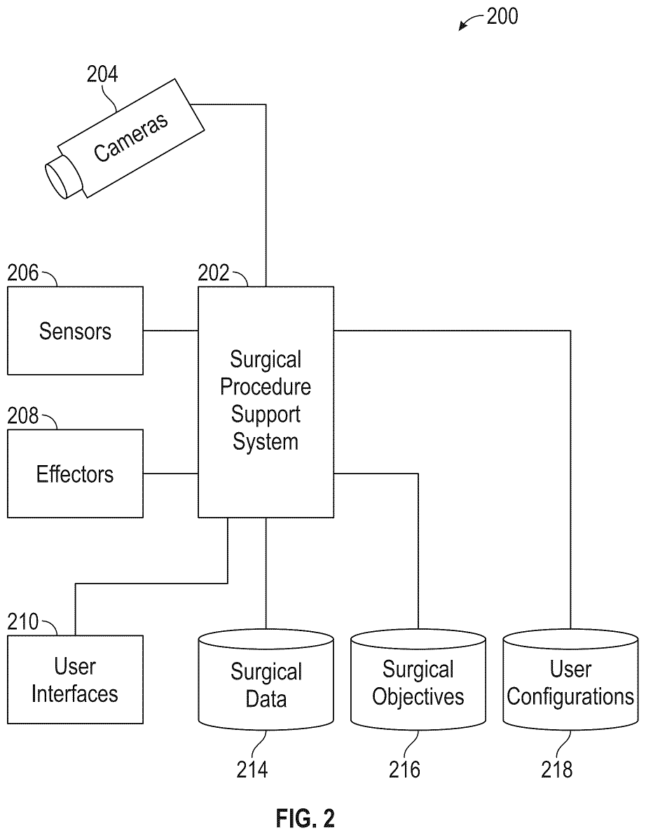

Turning now to FIG. 2, a surgical procedure system 200 is generally shown according to one or more aspects. The example of FIG. 2 depicts a surgical procedure support system 202 that can include or may be coupled to the CAS system 100 of FIG. 1. The surgical procedure support system 202 can acquire image or video data using one or more cameras 204. The surgical procedure support system 202 can also interface with one or more sensors 206 and/or one or more effectors 208. The sensors 206 may be associated with surgical support equipment and/or patient monitoring. The effectors 208 can be robotic components or other equipment controllable through the surgical procedure support system 202. The surgical procedure support system 202 can also interact with one or more user interfaces 210, such as various input and/or output devices. The surgical procedure support system 202 can store, access, and/or update surgical data 214 associated with a training dataset and/or live data as a surgical procedure is being performed on patient 110 of FIG. 1. The surgical procedure support system 202 can store, access, and/or update surgical objectives 216 to assist in training and guidance for one or more surgical procedures. User configurations 218 can track and store user preferences.

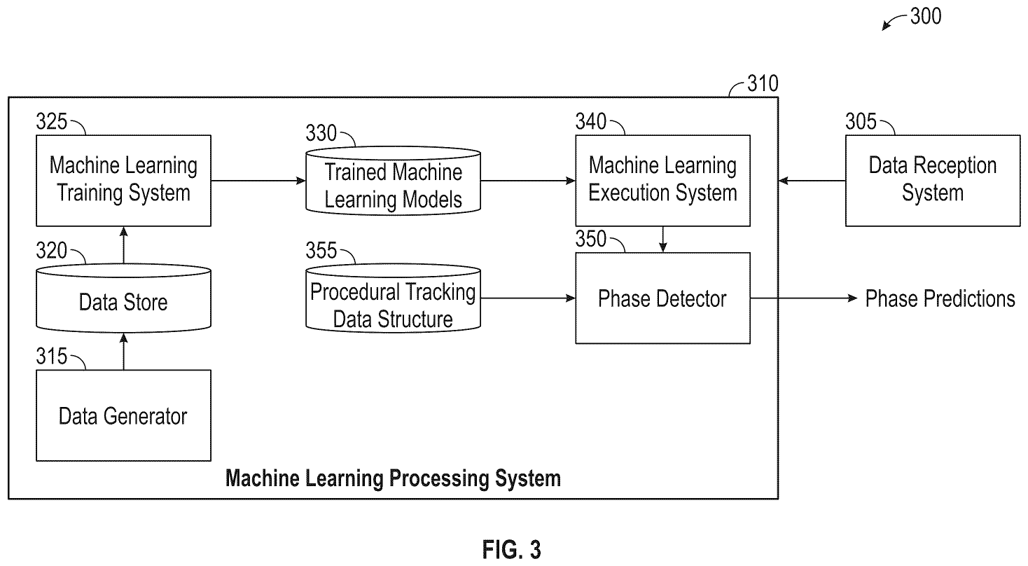

Turning now to FIG. 3, a system 300 for analyzing video and data is generally shown according to one or more aspects. In accordance with aspects, the video and data is captured from video recording system 104 of FIG. 1. The analysis can result in predicting features that include surgical phases and structures (e.g., instruments, anatomical structures, and/or the like including combinations and/or multiples thereof) in the video data using machine learning. System 300 can be the computing system 102 of FIG. 1, or a part thereof in one or more examples. System 300 uses data streams in the surgical data to identify procedural states according to some aspects.

System 300 includes a data reception system 305 that collects surgical data, including the video data and surgical instrumentation data. The data reception system 305 can include one or more devices (e.g., one or more user devices and/or servers) located within and/or associated with a surgical operating room and/or control center. The data reception system 305 can receive surgical data in real-time, i.e., as the surgical procedure is being performed. Alternatively, or in addition, the data reception system 305 can receive or access surgical data in an offline manner, for example, by accessing data that is stored in the data collection system 150 of FIG. 1.

System 300 further includes a machine learning processing system 310 that processes the surgical data using one or more machine learning models to identify one or more features, such as surgical phase, instrument, anatomical structure, and/or the like including combinations and/or multiples thereof, in the surgical data. It will be appreciated that machine learning processing system 310 can include one or more devices (e.g., one or more servers), each of which can be configured to include part or all of one or more of the depicted components of the machine learning processing system 310. In some instances, a part or all of the machine learning processing system 310 is cloud-based and/or remote from an operating room and/or physical location corresponding to a part or all of data reception system 305. It will be appreciated that several components of the machine learning processing system 310 are depicted and described herein. However, the components are just one example structure of the machine learning processing system 310, and that in other examples, the machine learning processing system 310 can be structured using a different combination of the components. Such variations in the combination of the components are encompassed by the technical solutions described herein.

The machine learning processing system 310 includes a machine learning training system 325, which can be a separate device (e.g., server) that stores its output as one or more trained machine learning models 330. The trained machine learning models 330 are accessible by a machine learning execution system 340. The machine learning execution system 340 can be separate from the machine learning training system 325 in some examples. In other words, in some aspects, devices that “train” the models are separate from devices that “infer,” i.e., perform real-time processing of surgical data using the trained machine learning models 330.

Machine learning processing system 310, in some examples, further includes a data generator 315 to generate simulated surgical data, such as a set of synthetic images and/or synthetic video, in combination with real image and video data from the video recording system 104, to generate trained machine learning models 330. Data generator 315 can access (read/write) a data store 320 to record data, including multiple images and/or multiple videos. The images and/or videos can include images and/or videos collected during one or more procedures (e.g., one or more surgical procedures). For example, the images and/or video may have been collected by a user device worn by the actor 112 of FIG. 1 (e.g., surgeon, surgical nurse, anesthesiologist, and/or the like including combinations and/or multiples thereof) during the surgery, a non-wearable imaging device located within an operating room, an endoscopic camera inserted inside the patient 110 of FIG. 1, and/or the like including combinations and/or multiples thereof. The data store 320 is separate from the data collection system 150 of FIG. 1 in some examples. In other examples, the data store 320 is part of the data collection system 150.

Each of the images and/or videos recorded in the data store 320 for performing training (e.g., generating the trained machine learning models 330) can be defined as a base image and can be associated with other data that characterizes an associated procedure and/or rendering specifications. For example, the other data can identify a type of procedure, a location of a procedure, one or more people involved in performing the procedure, surgical objectives, and/or an outcome of the procedure. Alternatively, or in addition, the other data can indicate a stage of the procedure with which the image or video corresponds, rendering specification with which the image or video corresponds and/or a type of imaging device that captured the image or video (e.g., and/or, if the device is a wearable device, a role of a particular person wearing the device, and/or the like including combinations and/or multiples thereof). Further, the other data can include image-segmentation data that identifies and/or characterizes one or more objects (e.g., tools, anatomical objects, and/or the like including combinations and/or multiples thereof) that are depicted in the image or video. The characterization can indicate the position, orientation, or pose of the object in the image. For example, the characterization can indicate a set of pixels that correspond to the object and/or a state of the object resulting from a past or current user handling. Localization can be performed using a variety of techniques for identifying objects in one or more coordinate systems.

The machine learning training system 325 uses the recorded data in the data store 320, which can include the simulated surgical data (e.g., set of synthetic images and/or synthetic video) and/or actual surgical data to generate the trained machine learning models 330. The trained machine learning models 330 can be defined based on a type of model and a set of hyperparameters (e.g., defined based on input from a client device). The trained machine learning models 330 can be configured based on a set of parameters that can be dynamically defined based on (e.g., continuous or repeated) training (i.e., learning, parameter tuning). Machine learning training system 325 can use one or more optimization algorithms to define the set of parameters to minimize or maximize one or more loss functions. The set of (learned) parameters can be stored as part of the trained machine learning models 330 using a specific data structure for a particular trained machine learning model of the trained machine learning models 330. The data structure can also include one or more non-learnable variables (e.g., hyperparameters and/or model definitions).

Machine learning execution system 340 can access the data structure(s) of the trained machine learning models 330 and accordingly configure the trained machine learning models 330 for inference (e.g., prediction, classification, and/or the like including combinations and/or multiples thereof). The trained machine learning models 330 can include, for example, a fully convolutional network adaptation, an adversarial network model, an encoder, a decoder, or other types of machine learning models. The type of the trained machine learning models 330 can be indicated in the corresponding data structures. The trained machine learning models 330 can be configured in accordance with one or more hyperparameters and the set of learned parameters.

The trained machine learning models 330, during execution, receive, as input, surgical data to be processed and subsequently generate one or more inferences according to the training. For example, the video data captured by the video recording system 104 of FIG. 1 can include data streams (e.g., an array of intensity, depth, and/or RGB values) for a single image or for each of a set of frames (e.g., including multiple images or an image with sequencing data) representing a temporal window of fixed or variable length in a video. The video data that is captured by the video recording system 104 can be received by the data reception system 305, which can include one or more devices located within an operating room where the surgical procedure is being performed. Alternatively, the data reception system 305 can include devices that are located remotely, to which the captured video data is streamed live during the performance of the surgical procedure. Alternatively, or in addition, the data reception system 305 accesses the data in an offline manner from the data collection system 150 or from any other data source (e.g., local or remote storage device).

The data reception system 305 can process the video and/or data received. The processing can include decoding when a video stream is received in an encoded format such that data for a sequence of images can be extracted and processed. The data reception system 305 can also process other types of data included in the input surgical data. For example, the surgical data can include additional data streams, such as audio data, RFID data, textual data, measurements from one or more surgical instruments/sensors, and/or the like including combinations and/or multiples thereof, that can represent stimuli/procedural states from the operating room. The data reception system 305 synchronizes the different inputs from the different devices/sensors before inputting them in the machine learning processing system 310.

The trained machine learning models 330, once trained, can analyze the input surgical data, and in one or more aspects, predict and/or characterize features (e.g., structures) included in the video data included with the surgical data. The video data can include sequential images and/or encoded video data (e.g., using digital video file/stream formats and/or codecs, such as MP4, MOV, AVI, WEBM, AVCHD, OGG, and/or the like including combinations and/or multiples thereof). The prediction and/or characterization of the features can include segmenting the video data or predicting the localization of the structures with a probabilistic heatmap. In some instances, the one or more trained machine learning models 330 include or are associated with a preprocessing or augmentation (e.g., intensity normalization, resizing, cropping, and/or the like including combinations and/or multiples thereof) that is performed prior to segmenting the video data. An output of the one or more trained machine learning models 330 can include image-segmentation or probabilistic heatmap data that indicates which (if any) of a defined set of structures are predicted within the video data, a location and/or position and/or pose of the structure(s) within the video data, and/or state of the structure(s). The location can be a set of coordinates in an image/frame in the video data. For example, the coordinates can provide a bounding box. The coordinates can provide boundaries that surround the structure(s) being predicted. The trained machine learning models 330, in one or more examples, are trained to perform higher-level predictions and tracking, such as predicting a phase of a surgical procedure and tracking one or more surgical instruments used in the surgical procedure.

While some techniques for predicting a surgical phase (“phase”) in the surgical procedure are described herein, it should be understood that any other technique for phase prediction can be used without affecting the aspects of the technical solutions described herein. In some examples, the machine learning processing system 310 includes a detector 350 that uses the trained machine learning models 330 to identify various items or states within the surgical procedure (“procedure”). The detector 350 can use a particular procedural tracking data structure 355 from a list of procedural tracking data structures. The detector 350 can select the procedural tracking data structure 355 based on the type of surgical procedure that is being performed. In one or more examples, the type of surgical procedure can be predetermined or input by actor 112. For instance, the procedural tracking data structure 355 can identify a set of potential phases that can correspond to a part of the specific type of procedure as “phase predictions”, where the detector 350 is a phase detector.

In some examples, the procedural tracking data structure 355 can be a graph that includes a set of nodes and a set of edges, with each node corresponding to a potential phase. The edges can provide directional connections between nodes that indicate (via the direction) an expected order during which the phases will be encountered throughout an iteration of the procedure. The procedural tracking data structure 355 may include one or more branching nodes that feed to multiple next nodes and/or can include one or more points of divergence and/or convergence between the nodes. In some instances, a phase indicates a procedural action (e.g., surgical action) that is being performed or has been performed and/or indicates a combination of actions that have been performed. In some instances, a phase relates to a biological state of a patient undergoing a surgical procedure. For example, the biological state can indicate a complication (e.g., blood clots, clogged arteries/veins, and/or the like including combinations and/or multiples thereof), pre-condition (e.g., lesions, polyps, and/or the like including combinations and/or multiples thereof). In some examples, the trained machine learning models 330 are trained to detect an “abnormal condition,” such as hemorrhaging, arrhythmias, blood vessel abnormality, and/or the like including combinations and/or multiples thereof.

Each node within the procedural tracking data structure 355 can identify one or more characteristics of the phase corresponding to that node. The characteristics can include visual characteristics. In some instances, the node identifies one or more tools that are typically in use or available for use (e.g., on a tool tray) during the phase. The node also identifies one or more roles of people who are typically performing a surgical task, a typical type of movement (e.g., of a hand or tool), and/or the like including combinations and/or multiples thereof. Thus, detector 350 can use the segmented data generated by machine learning execution system 340 that indicates the presence and/or characteristics of particular objects within a field of view to identify an estimated node to which the real image data corresponds. Identification of the node (i.e., phase) can further be based upon previously detected phases for a given procedural iteration and/or other detected input (e.g., verbal audio data that includes person-to-person requests or comments, explicit identifications of a current or past phase, information requests, and/or the like including combinations and/or multiples thereof).

The detector 350 can output predictions, such as a phase prediction associated with a portion of the video data that is analyzed by the machine learning processing system 310. The phase prediction is associated with the portion of the video data by identifying a start time and an end time of the portion of the video that is analyzed by the machine learning execution system 340. The phase prediction that is output can include segments of the video where each segment corresponds to and includes an identity of a surgical phase as detected by the detector 350 based on the output of the machine learning execution system 340. Further, the phase prediction, in one or more examples, can include additional data dimensions, such as, but not limited to, identities of the structures (e.g., instrument, anatomy, and/or the like including combinations and/or multiples thereof) that are identified by the machine learning execution system 340 in the portion of the video that is analyzed. The phase prediction can also include a confidence score of the prediction. Other examples can include various other types of information in the phase prediction that is output. Further, other types of outputs of the detector 350 can include state information or other information used to generate audio output, visual output, and/or commands. For instance, the output can trigger an alert, an augmented visualization, identify a predicted current condition, identify a predicted future condition, command control of equipment, and/or result in other such data/commands being transmitted to a support system component, e.g., through surgical procedure support system 202 of FIG. 2.

It should be noted that although some of the drawings depict endoscopic videos being analyzed, the technical solutions described herein can be applied to analyze video and image data captured by cameras that are not endoscopic (i.e., cameras external to the patient's body) when performing open surgeries (i.e., not laparoscopic surgeries). For example, the video and image data can be captured by cameras that are mounted on one or more personnel in the operating room (e.g., surgeon). Alternatively, or in addition, the cameras can be mounted on surgical instruments, walls, or other locations in the operating room. Alternatively, or in addition, the video can be images captured by other imaging modalities, such as ultrasound.

As described regarding FIGS. 1-3, it is often desirable to perform computer vision applications during or after surgical procedures, such as to perform surgical phase annotation, surgical instrument detection and tracking, anatomy localization and segmentation, and/or the like, including combinations and/or multiples thereof. For example, one or more aspects provides a vision backbone for generating spatial-temporal features to power online and offline models for computer vision applications (e.g., anatomy segmentation, surgical instrument detection, and/or other surgical vision tasks). One or more aspects described herein provide a low latency approach for processing a sequence of frames of a video and generating robust spatial-temporal features. One or more aspects described herein provide adaptive control of computational resources to run more models on relatively low powered processing systems, such as edge devices. According to one or more aspects, processing needs can be adjusted for post-operative video models to speed up inference and reduce processing resource costs, such as the computing costs of using graphical processing unit for performing post-operative video analytics. These and other aspects are now described in more detail.

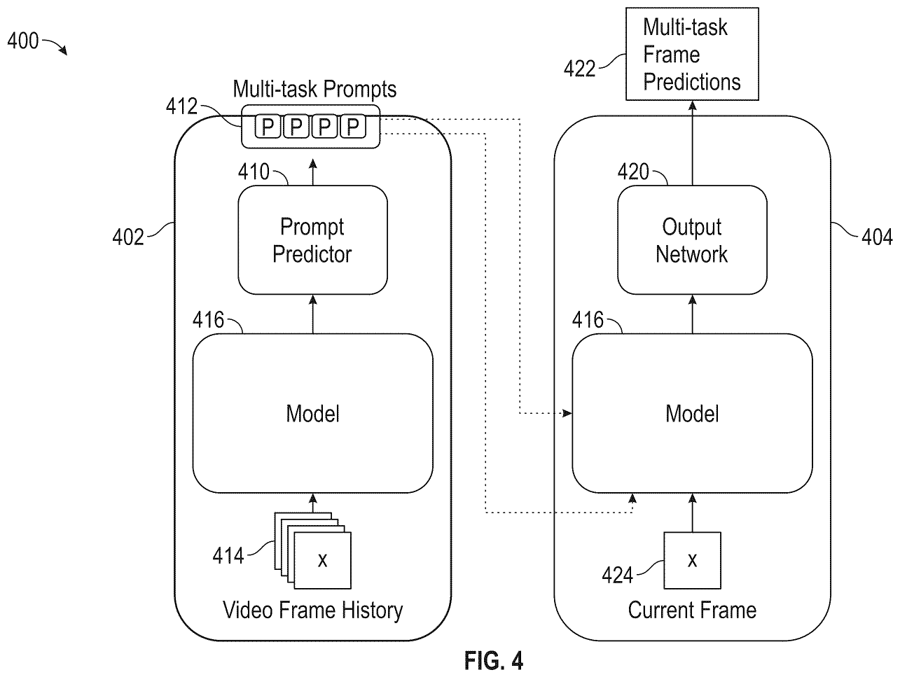

One or more aspects described herein provide a multi-task prompt learning (MTPL) model. For example, FIG. 4 depicts a network 400 according to one or more aspects that utilizes a MTPL model 416, which provides a simple, low computation approach for learning temporal context from a history of frames for various video-processing tasks (e.g., anatomy segmentation, surgical instrument detection, and/or other surgical vision tasks).

According to one or more aspects, the network 400 provides for multi-task prompt learning, which addresses issues with simultaneously running different models on relatively low powered processing systems. For example, the size of the GPU of relatively low powered processing systems often prohibits running more than a few (e.g., more than two or three) models in parallel. The STMN model 400 can be adapted towards a multi-task learning model by generating multi-task temporal prompts. This approach provides benefits including running a single model with a light-weight module for generating multi-task temporal prompts for efficient deployment on relatively low powered processing systems.

According to one or more aspects, the network 400 aggregates task-specific temporal features in a video feed to aid prediction for new frames. According to one or more aspects, the network 400 learns cross-task temporal context. For example, each task can use information useful for itself from task-prompts. According to one or more aspects, the network 400 enables real-time (or near-real-time) multi-task learning on videos without the need for complex and slow architectures.

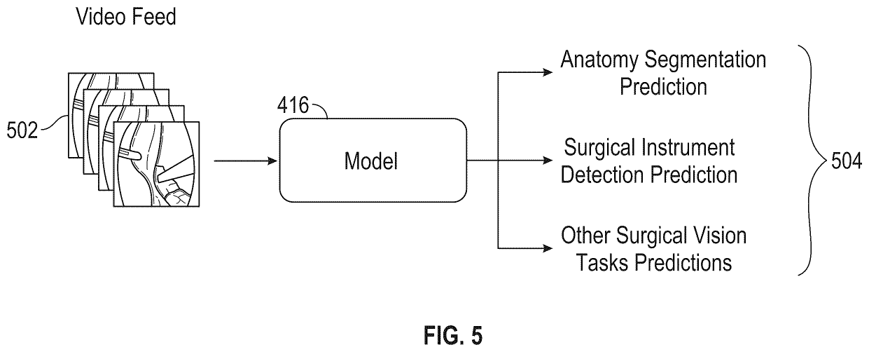

The network 400 includes a prompting stage 402 to generate multi-task prompts 412 and a prediction stage 404 to generate multi-task frame predictions 422. Both the prompting stage 402 and the prediction stage 404 utilize a multi-task inter-operative model 416 (also referred to as “model 416” for simplicity), which is a unified model for processing a surgical videos (or images extracted from surgical videos) that can make multiple predictions in parallel. The model 416 outputs consistent predictions across tasks. As shown in FIG. 5, the model 416 takes in images 502 from a video feed of a surgical procedure and generates predictions 504 for various tasks (e.g., anatomy segmentation, surgical instrument detection, and/or other surgical vision tasks).

According to one or more aspects, the model 416 model extends a spatio-temporal prompting network (STPN), which has demonstrated desirable performance in capturing spatio-temporal (also referred to as “spatial temporal”) context in video analysis tasks. The STPN utilizes learnable prompts to effectively encode temporal information across video frames, providing a solid foundation for the temporal multi-task learning (MTL) approach described herein.

With continued reference to FIG. 4, during the prompting stage 402, the model 416 receives a history of video frames (e.g., video frame history 414), which may be images extracted from a video feed of a surgical procedure (e.g., images 502). The model 416, in combination with a prompt predictor 410, generates multi-task prompts 412 from the video frame history 414. When processing a current frame 424 during the prediction stage 404, the multi-task prompts 414 are exploited by the model 416 to generate multi-task frame predictions 422 using an output network 420.

The model 416 implements a cross-task prompt network (CTPN) and a prompt refinement decoder head (PRDH) to generate the multi-task prompts 412 during the prompting stage 402 and to generate the multi-task frame predictions 422 during the prediction stage 404, respectively. More particularly, the CTPN generates task-specific prompts while leveraging shared knowledge across tasks. The CTPN can use a transformer architecture for learning temporal task-specific prompts according to one or more aspects. This module enhances the ability of the model 416 to capture task-specific spatio-temporal patterns while facilitating information exchange between related tasks. The PRDH provides a decoding mechanism that utilizes task-specific prompts to refine predictions for each task. The PRDH can use a transformer-based architecture to merge task-specific temporal information and current frame context to make a prediction according to one or more aspects. The PRDH allows for more nuanced task-specific feature extraction while maintaining the benefits of shared representations.

The CTPN and the PRDH work together to address challenges of temporal modeling and task interaction in surgical video analysis. The CTPN enables mor effective capture of task-relevant temporal features while the PRDH provides for task-specific refinement of shared representations. Together, the CTPN and the PRDH provide a flexible and powerful framework for temporal MTL that can adapt to the complex and dynamic nature of surgical videos.

According to one or more aspects, the network 400 is a spatio-temporal prompting network (STPN). STPN is designed to effectively capture both spatial and temporal information in video analysis tasks and is divided into stages as follows.

A first stage aims to generate a set of prompts that capture the spatio-temporal information. It begins by selecting K support frames Iₛᵤₚₚ around a key frame Iₜ. It then uses its STPN Swin-T backbone to extract support image embeddings Eₛᵤₚₚ. These embeddings are then passed to the dynamic video prompt (DVP) predictor to generate N_{P} dynamic video prompts P. These contain the spatio-temporal information of the current video.

A second stage is designed to extract spatio-temporal features of the key frame Iₜ using the dynamic prompt P. Specifically, this process can be formulated as:

$$[ {Z}_{t}^{1} , {E}_{t}^{1} ] = {L}^{1} ( Concat ( P , {E}_{t} ) )$$

$$[ {Z}_{t}^{i} , {E}_{t}^{i} ] = {L}^{i} ( Concat ( {Z}_{t}^{i - 1} , {E}_{t}^{i - 1} ) ) i = 2 , 3 , … , L$$

$${y}_{t} = Head ( {E}_{i}^{L} )$$

where Concat(⋅) means the concatenation,

$$\text{?} ∈ \text{?}$$

$$\text{?} \text{indicates text missing or illegible when filed}$$

is the extra embedding produced by adding P in the input embeddings, and L is the transformer layer in the backbone model. At the end, the output embedding

$$\text{?}$$

$$\text{?} \text{indicates text missing or illegible when filed}$$

are passed into the head network for various tasks.

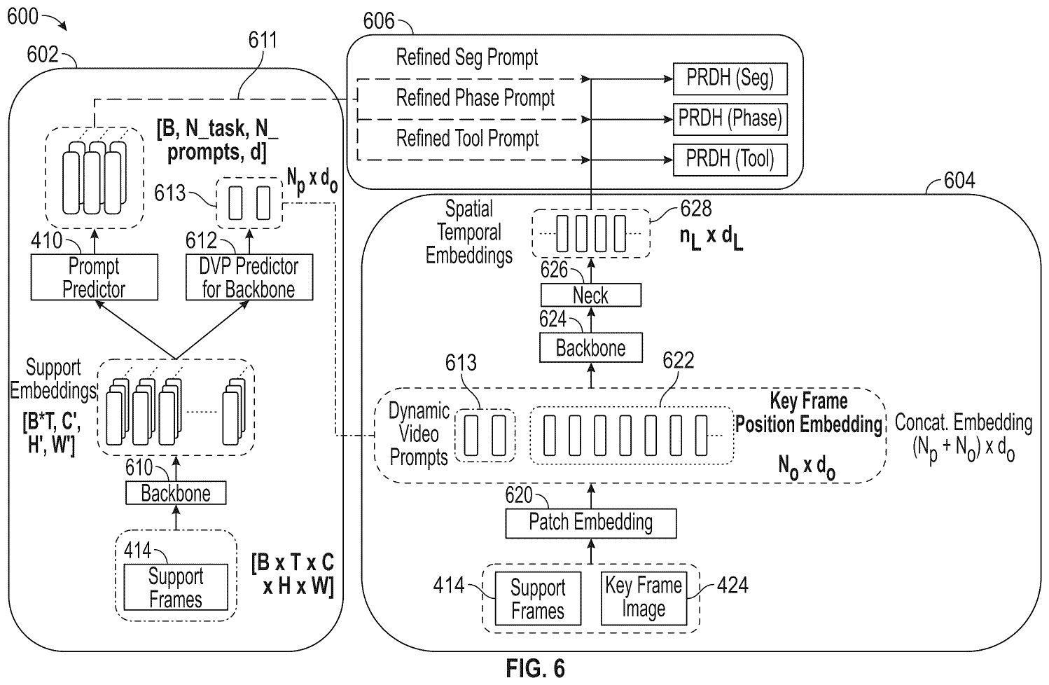

FIG. 6 depicts an architecture 600 for performing multi-task prompt prediction 602, processing a current frame in a video feed 604, and generating multi-task frame predictions 606, according to one or more aspects. The network 600 can include various features, functions, and/or components, such as, a backbone network 610, a dynamic visual prompt (DVP) predictor 612, and the prompt predictor 410.

Multi-task prompt prediction 602 is now described. Video frame history 414 (also referred to as “support frames”) includes images (e.g., the images 502), which are passed into the backbone network 610. The video frame history 414 has a vector(s) associated therewith that designates the batch size B, time T (e.g., window size of history), channel dimensions C of the image(s), height H of the image(s), and width W of the image(s) as follows: [B×T×C×H×W]. The backbone network 610 can be a vision transformer backbone (e.g., a Swin Transformer, a Convolutional Neural Network, and/or the like, including combinations and/or multiples thereof)), which has been adapted to accommodate a prompt-based input. Embeddings are then generated based on the output of the backbone network 610. The embeddings modify the vector as follows [B*T, C′, H′, W′], where ′ indicates that the original value was modified. For example, H′ and W′ may be different height and width values for an image based on image resizing performed by the backbone network 610.

The support embeddings are passed to the prompt predictor 410 and the DVP predictor 612. The prompt predictor 410 generates prompts 611 for various tasks, such as a segmentation prompt for an anatomy segmentation task, a phase prompt for a surgical phase prediction task, and a tool prompt for a surgical instrument detection task. The prompts can be formatted as a vector [B, Nₜₐₛₖ, Nₚᵣₒₘₚₜₛ, d], where B is the batch size, Nₜₐₛₖ is a number of tasks, Nₚᵣₒₘₚₜₛ is a number of prompts per task (which can be a hyperparameter), and d is dimensionality of the vector. The DVP predictor 612 uses the embeddings to generate a set of dynamic video prompts 613 (also referred to as “dynamic visual prompts”).

The dynamic video prompts 613 are used during processing a current frame (e.g., current frame 424 (also referred to as a “key frame image”)) in a video feed 604, which is now described in more detail. The current frame 424 is received along with images of the video frame history 414, and patch embedding 620 is performed to generate keyframe position embeddings 622. The key frame position embeddings are concatenated with the dynamic video prompts 613 to produce spatio-temporal embeddings 628 for various decoder heads using a backbone 624 and a neck 626. The backbone 624 may be a Swin-T vision transformer or another suitable architecture for performing dense prediction tasks in computer vision, for example. According to one or more aspects, the backbone 624 uses a Swin-T transformer that processes the image tokens through a series of transformer blocks and implements shifted windows and patch merging. From the backbone 624, the processing a current frame in a video feed 604 proceeds to neck 626, which generates the spatio-temporal embeddings 628.

The spatio-temporal embeddings 628 are combined with the prompts 611 for various tasks to perform generating multi-task frame predictions 606. For example, during generating multi-task frame predictions 606, the prompts 611 are prepended with the patch embeddings of the key frame image (e.g., the current frame 424) to extract spatio-temporal embeddings via the STPN Swin-T backbone 624 and neck 626 and output final results for various tasks.

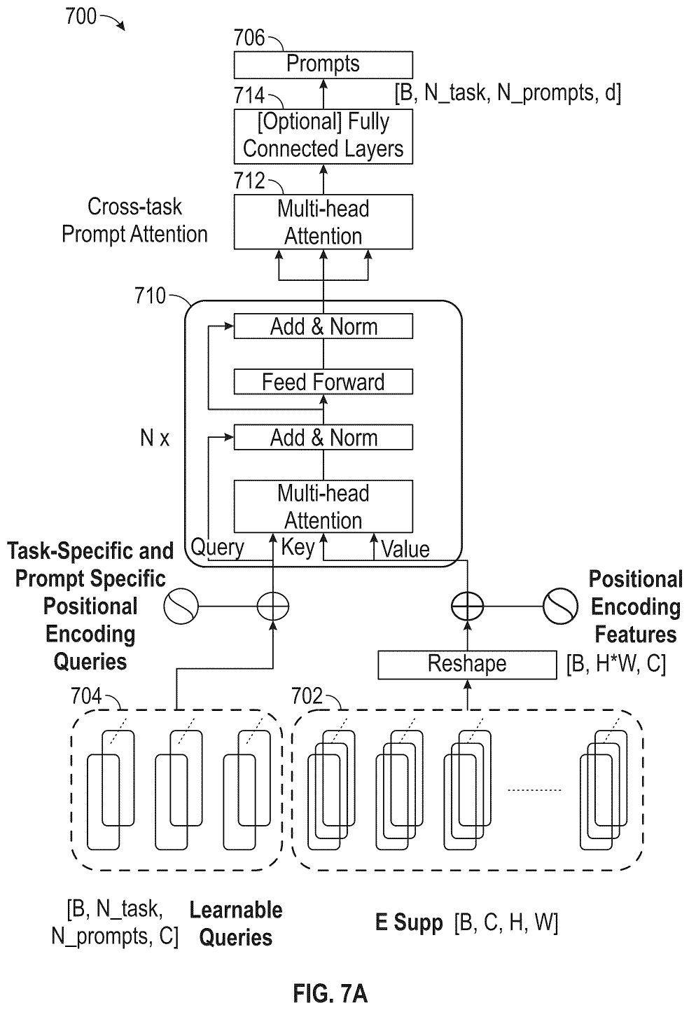

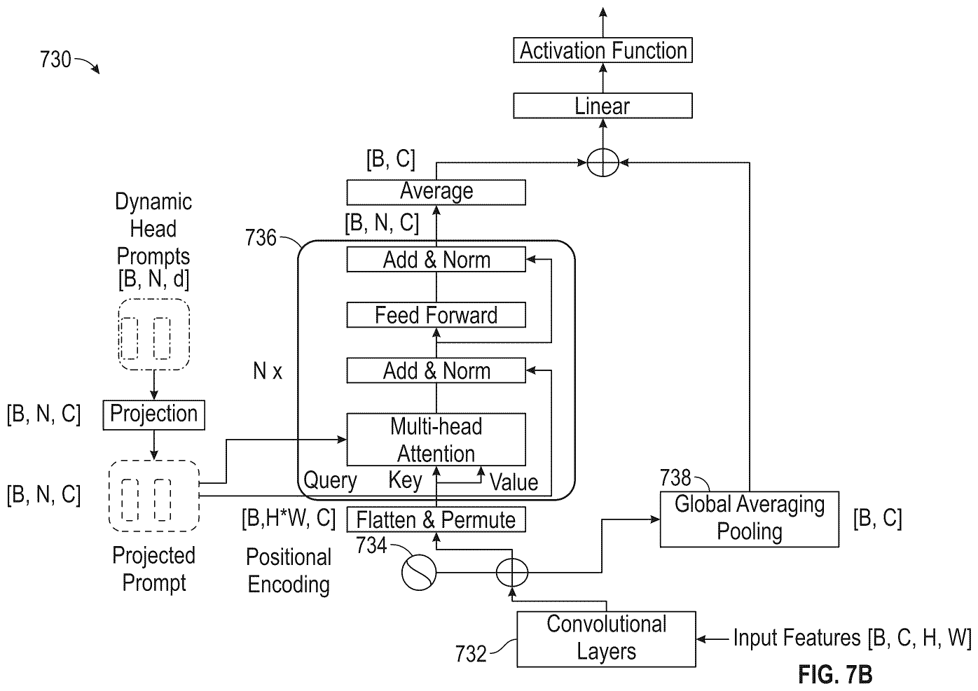

Further features of the CTPN are now described in more detail with reference to FIG. 7A. In particular, FIG. 7A depicts aspects of a cross-task prompt network 700 according to one or more aspects described herein. The CTPM 700 takes support embeddings Eₛᵤₚₚ 702 and a set of learnable queries 704 as input and generates refined task-specific prompts 706 through a series of transformer layers 710, a cross-task attention module 712, and optional fully connected (FC) layers 714.

More particularly, according to one or more aspects, the CTPN 700 uses a set of learnable task-specific queries of shape [B, Nₜₐₛₖ, Nₚᵣₒₘₚₜₛ, C], where Nₜₐₛₖ is the number of tasks and Nₚᵣₒₘₚₜₛ is the number of prompts per task. Both the reshaped features and the learnable queries are augmented with task-specific and prompt-specific positional encodings to retain spatial information. The CTPN 700 use “N” transformer layers 710. Each layer includes a multi-head attention (MHA) mechanism, followed by add & norm operations, and a feed-forward network (FFN). In the MHA, the queries attend to the Eₛᵤₚₚ, allowing each task-specific prompt to extract relevant information from the input. This process enables the queries to gradually specialize into task-specific information through the attention and MLP layers, capturing unique temporal patterns relevant to each task.

After the N transformer layers 710, a cross-task prompt attention mechanism is applied as cross-task attention module 712. This allows for information exchange between different tasks, enabling the model 416 to leverage task relationships and shared knowledge. The behavior of this approach can adapt based on the number of tasks. In a multi-task scenario, it performs cross-task attention, facilitating information flow between different tasks. According to one or more aspects, the learnt prompts are passed through an extra fully-connected (FC) layers 714 to ensure they capture task-relevant information. However, when the CTP network is used for a single task, this module effectively becomes a self-attention mechanism for that task. In this case, it allows the model to refine and consolidate task-specific information without cross-task interactions.

The prompts 706 are generated as output of the CTPN 700 as Pₜₐₛₖ, which are a set of refined task-specified prompts of shape [B, Tₜₐₛₖ, Nₚᵣₒₘₚₜₛ, d]. These prompts 706 encapsulate task-specific information extracted from the input features and can be used to guide the subsequent task-specific prediction heads. The architecture of the CTPN 700 enables the model 416 to dynamically adapt to different tasks and input features, providing a flexible and powerful mechanism for multi-task learning in a video object detection framework.

Further features of the PRDH are now described in more detail with reference to FIG. 7B. In particular, FIG. 7B depicts aspects of a prompt refinement decoder head 730 for single/multi-task learning in video analysis according to one or more aspects described herein. The PRDH 730 is a flexible design that can be adapted for various tasks, such as tool detection, phase recognition, or semantic segmentation in surgical video understanding.

According to one or more aspects, the architecture of the PRDH 730 can be applied for phase recognition and tool presence detection. In other aspects, the PRDH 730 can be applied to semantic segmentation. The model 416, using the PRDH 730, processes input features through convolutional layers 732 and combines them with positional embeddings 734. Projected Pₜₐₛₖ are refined through multiple transformer layers 736 using cross-attention with the visual features. The refined prompts are then combined with global average pooled features from global averaging pooling 738 for final prediction.

The PRDH 730 processes the output features from the backbone, in prompting stage, through convolutional layers and combines them with positional embeddings to preserve spatial information. Task-specific prompts are selected at one index along the task axis resulting in the shape [B, Nₚᵣₒₘₚₜₛ, d]. They are projected to match the feature dimensions (i.e., from shape [B, Nₜₐₛₖ, Nₚᵣₒₘₚₜₛ, d] to [B, Nₜₐₛₖ, Nₚᵣₒₘₚₜₛ, C]). The core of this architecture lies in the transformer layers 732, where cross-attention is computed between the visual features and the prompts. Formally, in each decoder head, given visual features X∈ [symbol] ^{B×HW×C} and prompts, Pₜₐₛₖ∈ [symbol] ^{B×N}^{ₚᵣₒₘₚₜₛ}^{×C}, the cross-attention is computed as:

$$Attention ( {P}_{task} , X ) = soft max ( \frac{{P}_{task} {X}^{T}}{\sqrt{C}} ) X$$

A difference between the variants of PRDH 730 lies in how the global context is captured and how the attention mechanisms are applied. For classification tasks, a global averaging pooling 738 operation is applied to provide a prompt-independent global representation of the current frame 424. The final prediction for these tasks is computed as:

$$y = FC ( GAP ( X ) + f ( {P}_{task}^{′} ) )$$

where

$${P}_{task}^{′}$$

is the refined task prompt after the transformer layers 736 and ƒ can be any function to aggregate the N prompts. According to one or more aspects, ƒ(x) is chosen to be the mean.

For dense prediction tasks like semantic segmentation, the PRDH 730 introduces a spatial attention module, which generates a spatial attention map applied to the feature maps. Instead of using GAP, the refined prompts generate channel-wise attention:

$$A = σ ( f ( {P}_{task}^{′} ) )$$

where σ is the sigmoid function, and A∈ [symbol] ^{B×C×1×1} is the channel-wise attention. The final prediction for segmentation tasks combines the original features, spatially-attended features, and prompt-attended features:

$$y = FC ( X + {X}_{spatial} + X \cdot ( 1 + A ) )$$

where Xₛₚₐₜᵢₐₗ is the output of the spatial attention module. The GAP can be deployed and the spatial attention model in this framework.

This unified design allows the PRDH 730 to adapt to different tasks by leveraging appropriate attention mechanisms and task prompts.

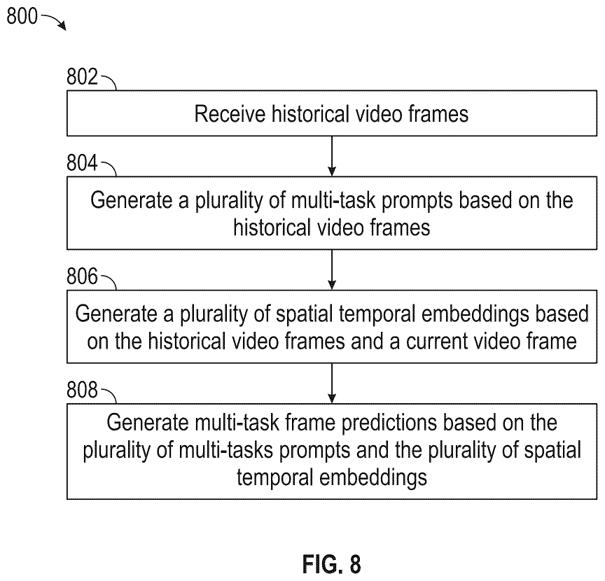

Turning now to FIG. 8, a flow diagram of a method 800 for generating multi-task frame predictions for a current frame of a video of a surgical procedure according to one or more aspects described herein. The method 800 can be performed by any suitable system or device, such as the computing system 102 of FIG. 1, the surgical procedure support system 202 of FIG. 2, the machine learning processing system 310 of FIG. 3, and/or the processing system 900 of FIG. 9. According to one or more aspects, the method 800 is implemented by the machine learning execution system 340. FIG. 8 is now described in more detail with reference to FIGS. 5 and 6 but is not so limited.

At block 802, the machine learning execution system 340 receives historical video frames. At block 804, the machine learning execution system 340 generates a plurality of multi-task prompts based on the historical video frames. At block 806, the machine learning execution system 340 generates a plurality of spatial temporal embeddings based on the historical video frames and a current video frame. At block 808, the machine learning execution system 340 generates multi-task frame predictions based on the plurality of multi-task prompts and the plurality of spatial temporal embeddings.

Additional processes also may be included, and it should be understood that the processes depicted in FIG. 8 represent illustrations, and that other processes may be added or existing processes may be removed, modified, or rearranged without departing from the scope of the present disclosure. It should also be understood that the processes depicted in FIG. 8 may be implemented as programmatic instructions stored on a non-transitory computer-readable storage medium that, when executed by a processor (e.g., one or more of the processors 921 of FIG. 9) of a computing system (e.g., the processing system 900 of FIG. 9), cause the processor to perform the processes described herein.

It is understood that one or more aspects described herein is capable of being implemented in conjunction with any other type of computing environment now known or later developed. For example, FIG. 9 depicts a block diagram of a processing system 900 for implementing the techniques described herein. In accordance with one or more aspects described herein, the processing system 900 is an example of a cloud computing node of a cloud computing environment. In examples, processing system 900 has one or more central processing units (referred to also as “processors” or “processing resources” or “processing devices”) 921a, 921b, 921c, etc. (collectively or generically referred to as processor(s) 921 and/or as processing device(s)). In aspects of the present disclosure, each processor 921 can include a reduced instruction set computer (RISC) microprocessor. Processors 921 are coupled to a system memory 922 and/or various other components via a system bus 933. The system memory 922 can include one or more temporary and/or persistent memory devices, such as a random access memory (RAM) 923, a read-only memory (ROM) 924, and/or the like, including combinations and/or multiples thereof. The system bus 933 may include a basic input/output system (BIOS), which controls certain basic functions of processing system 900.

Further depicted are an input/output (I/O) adapter 927 and a network adapter 926 coupled to system bus 933. I/O adapter 927 may be a small computer system interface (SCSI) adapter that communicates with a hard disk 935 and/or a storage device 936 or any other similar component. I/O adapter 927, hard disk 935, and storage device 936 are collectively referred to herein as mass storage 934. Operating system 940 for execution on processing system 900 may be stored in mass storage 934. The network adapter 926 interconnects system bus 933 with an outside network 938 enabling processing system 900 to communicate with other such systems.

A display (e.g., a display monitor) 939 is connected to system bus 933 by display adapter 932, which may include a graphics adapter to improve the performance of graphics intensive applications and a video controller. In one aspect of the present disclosure, adapters 926, 927, and/or 932 may be connected to one or more I/O buses that are connected to system bus 933 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 933 via user interface adapter 928 and display adapter 932. A keyboard 929, mouse 930, and speaker 931 may be interconnected to system bus 933 via user interface adapter 928, which may include, for example, a Super I/O chip integrating multiple device adapters into a single integrated circuit.

In some aspects of the present disclosure, processing system 900 includes a GPU 937. Graphics processing unit 937 is a specialized electronic circuit designed to manipulate and alter memory to accelerate the creation of images in a frame buffer intended for output to a display. In general, graphics processing unit 937 is very efficient at manipulating computer graphics and image processing, and has a highly parallel structure that makes it more effective than general-purpose CPUs for algorithms where processing of large blocks of data is done in parallel.

Thus, as configured herein, processing system 900 includes processing capability in the form of processors 921, storage capability including the system memory 922 and mass storage 934, input means such as keyboard 929 and mouse 930, and output capability including speaker 931 and display 939. In some aspects of the present disclosure, a portion of system memory 922 and mass storage 934 collectively store the operating system 940 to coordinate the functions of the various components shown in processing system 900.

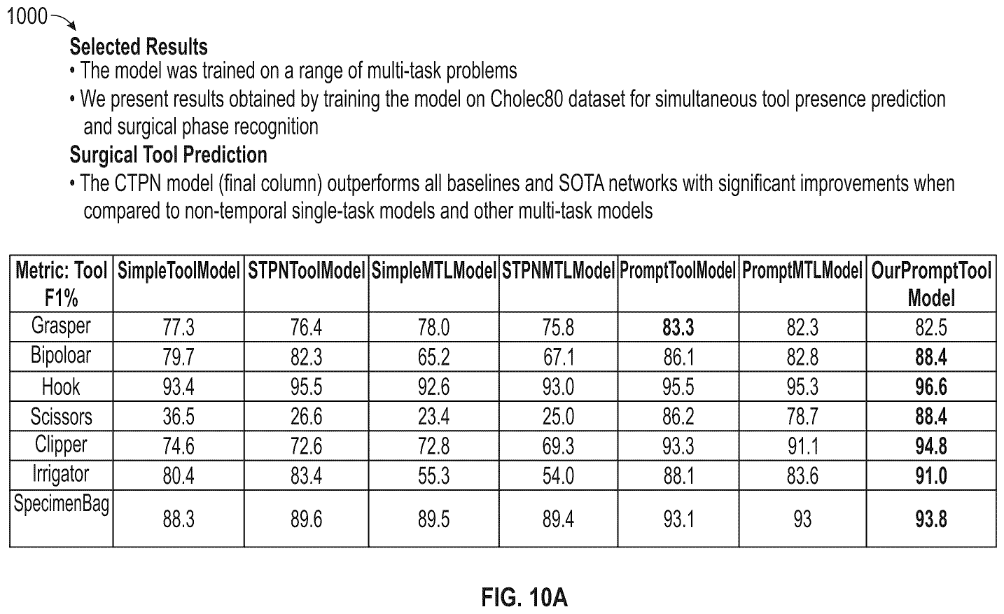

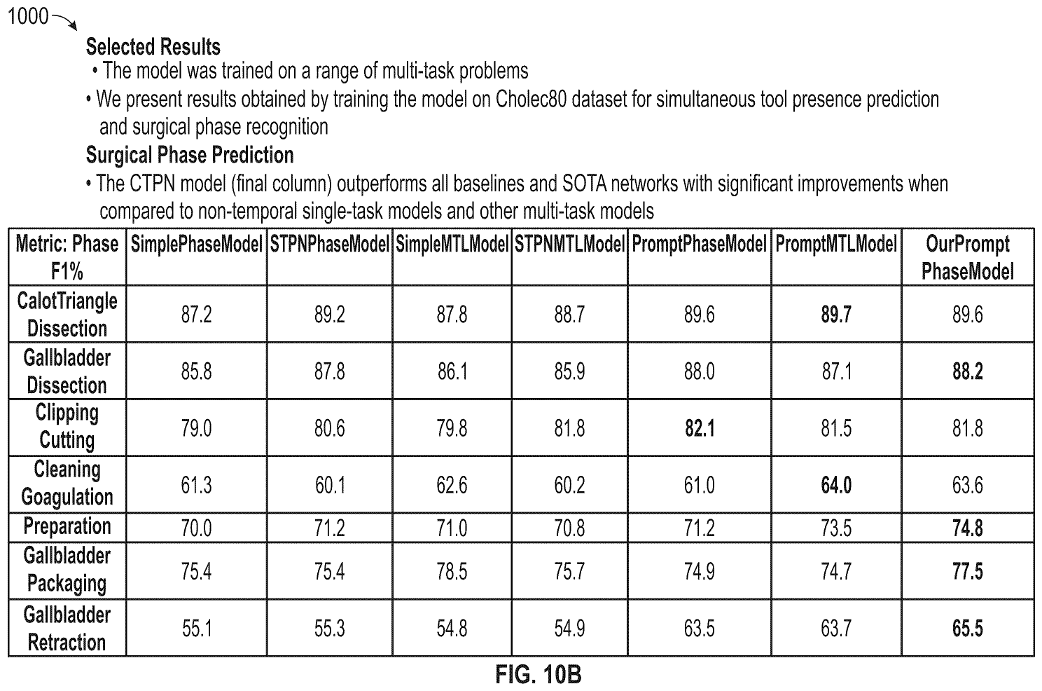

FIGS. 10A and 10B together depict selected results 1000 according to one or more aspects.

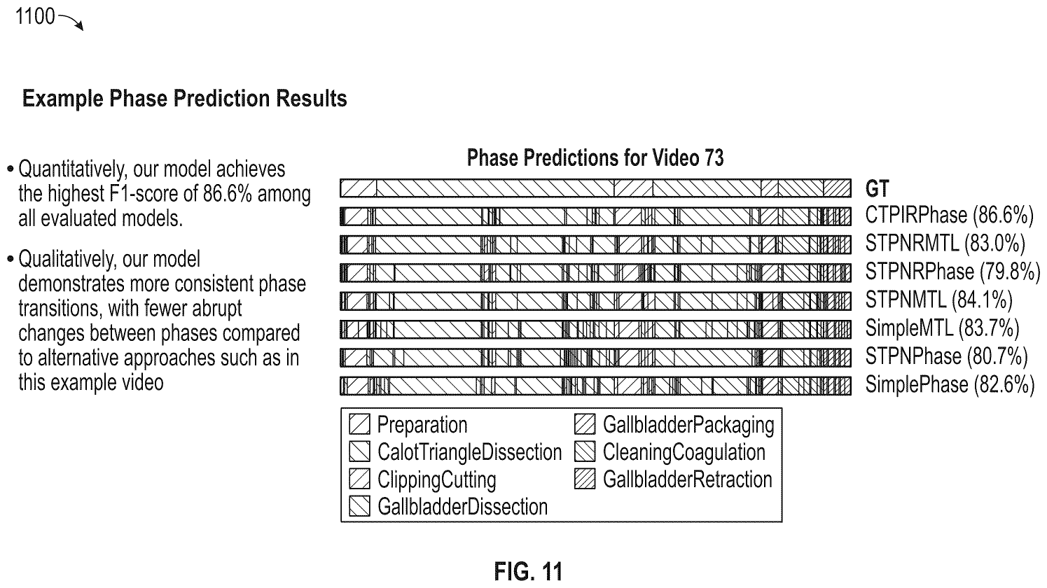

FIG. 11 depicts example phase prediction results 1100 according to one or more aspects described herein.

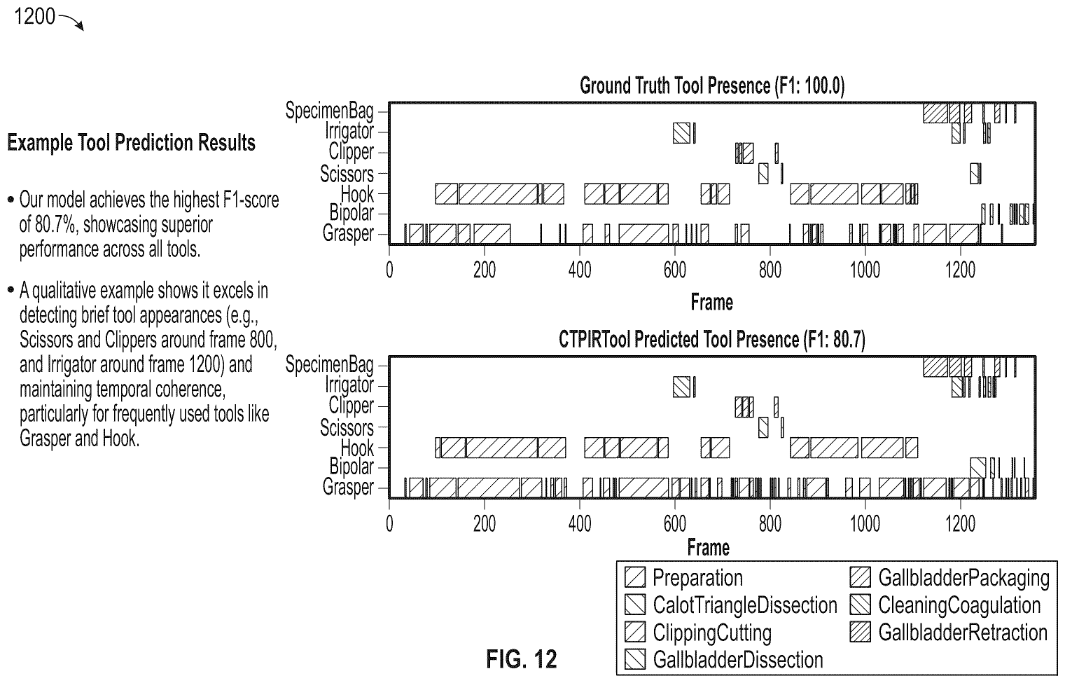

FIG. 12 depicts example tool prediction results 1200 according to one or more aspects described herein

Aspects described herein may be a system, a method, and/or a computer program product at any possible technical detail level of integration. The computer program product may include a computer-readable storage medium (or media) having computer-readable program instructions thereon for causing a processor to carry out aspects described herein.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network, and/or a wireless network. The network may comprise copper transmission cables, optical transmission fibers, wireless transmission, routers, firewalls, switches, gateway computers, and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations described herein may be assembler instructions, instruction-set-architecture (ISA) instructions, machine instructions, machine-dependent instructions, microcode, firmware instructions, state-setting data, configuration data for integrated circuitry, or either source-code or object code written in any combination of one or more programming languages, including an object-oriented programming language such as Smalltalk, C++, high-level languages such as Python, or the like, and procedural programming languages, such as the “C” programming language or similar programming languages. The computer-readable program instructions may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some aspects, electronic circuitry including, for example, programmable logic circuitry, field-programmable gate arrays (FPGA), or programmable logic arrays (PLA) may execute the computer-readable program instruction by utilizing state information of the computer-readable program instructions to personalize the electronic circuitry, in order to perform aspects described herein.

Aspects are described herein with reference to flowchart illustrations and/or block diagrams of methods, apparatus (systems), and computer program products according to aspects described herein. It will be understood that each block of the flowchart illustrations and/or block diagrams, and combinations of blocks in the flowchart illustrations and/or block diagrams, can be implemented by computer-readable program instructions.

These computer-readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other device to cause a series of operational steps to be performed on the computer, other programmable apparatus or other devices to produce a computer-implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various aspects described herein. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various aspects described herein have been presented for purposes of illustration but are not intended to be exhaustive or limited to the aspects disclosed. Many modifications and variations will be apparent to those of ordinary skill in the art without departing from the scope of the described aspects. The terminology used herein was chosen to best explain the principles of the aspects, the practical application or technical improvement over technologies found in the marketplace, or to enable others of ordinary skill in the art to understand the aspects described herein.

Various aspects are described herein with reference to the related drawings. Alternative aspects can be devised without departing from the scope of the aspects described herein. Various connections and positional relationships (e.g., over, below, adjacent, etc.) are set forth between elements in the following description and in the drawings. These connections and/or positional relationships, unless specified otherwise, can be direct or indirect, and the present disclosure is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains,” or “containing,” or any other variation thereof are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any aspect or design described herein as “exemplary” is not necessarily to be construed as preferred or advantageous over other aspects or designs. The terms “at least one” and “one or more” may be understood to include any integer number greater than or equal to one, i.e., one, two, three, four, etc. The terms “a plurality” may be understood to include any integer number greater than or equal to two, i.e., two, three, four, five, etc. The term “connection” may include both an indirect “connection” and a direct “connection.”

The terms “about,” “substantially,” “approximately,” and variations thereof are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using the aspects described herein may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

It should be understood that various aspects disclosed herein may be combined in different combinations than the combinations specifically presented in the description and accompanying drawings. It should also be understood that, depending on the example, certain acts or events of any of the processes or methods described herein may be performed in a different sequence, may be added, merged, or left out altogether (e.g., all described acts or events may not be necessary to carry out the techniques). In addition, while certain aspects of this disclosure are described as being performed by a single module or unit for purposes of clarity, it should be understood that the techniques of this disclosure may be performed by a combination of units or modules associated with, for example, a medical device.

In one or more examples, the described techniques may be implemented in hardware, software, firmware, or any combination thereof. If implemented in software, the functions may be stored as one or more instructions or code on a computer-readable medium and executed by a hardware-based processing unit. Computer-readable media may include non-transitory computer-readable media, which corresponds to a tangible medium such as data storage media (e.g., RAM, ROM, EEPROM, flash memory, or any other medium that can be used to store desired program code in the form of instructions or data structures and that can be accessed by a computer).

Instructions may be executed by one or more processors, such as one or more digital signal processors (DSPs), general-purpose microprocessors, application-specific integrated circuits (ASICs), field programmable logic arrays (FPGAs), or other equivalent integrated or discrete logic circuitry. Accordingly, the term “processor” as used herein may refer to any of the foregoing structure or any other physical structure suitable for implementation of the described techniques. Also, the techniques could be fully implemented in one or more circuits or logic elements.

What is claimed is:

1. A computer-implemented method for generating multi-task frame predictions for a current frame of a video of a surgical procedure, the method comprising:
receiving historical video frames;
generating a plurality of multi-task prompts based on the historical video frames;
generating a plurality of spatial temporal embeddings based on the historical video frames and a current video frame; and
generating the multi-task frame predictions based on the plurality of multi-task prompts and the plurality of spatial temporal embeddings.

2. The computer-implemented method of claim 1, wherein generating the plurality of multi-task prompts is performed using a cross-task prompt network.

3. The computer-implemented method of claim 2, wherein the cross-task prompt network receives support embeddings and a set of learnable queries as input and generates refined task-specific prompts through a series of transformer layers, a cross-task attention module, and fully connected layers.

4. The computer-implemented method of claim 3, wherein the series of transformer layers comprises a multi-head attention mechanism, a first add and normalize operation, a feed-forward network, and a second add and normalize operation.

5. The computer-implemented method of claim 1, wherein generating the plurality of multi-task prompts is performed using a prompt refinement decoder head.

6. The computer-implemented method of claim 1, wherein generating the plurality of multi-task prompts is performed using a cross-task prompt network and a prompt refinement decoder head.

7. The computer-implemented method of claim 1, wherein the multi-task frame predictions comprise refined segmentation prompts, refined phase prompts, and refined tule prompts.

8. The computer-implemented method of claim 1, wherein generating the multi-task frame predictions comprises prepending the plurality of multi-task prompts with patch embeddings of a key frame image to extract the plurality of spatial temporal embeddings.

9. The computer-implemented method of claim 1, wherein each of the plurality of multi-task prompts are formatted as a vector [B, Nₜₐₛₖ, Nₚᵣₒₘₚₜₛ, d], where B is a batch size, Nₜₐₛₖ is a number of tasks, Nₚᵣₒₘₚₜₛ is a number of prompts per task, and d is dimensionality of the vector.

10. A computer system comprising:
a processor set;
one or more computer-readable storage media; and
program instructions stored on the one or more computer-readable storage media to cause the processor set to perform operations for generating multi-task frame predictions for a current frame of a video of a surgical procedure, the operations comprising:
receiving historical video frames;
generating a plurality of multi-task prompts based on the historical video frames;
generating a plurality of spatial temporal embeddings based on the historical video frames and a current video frame; and
generating the multi-task frame predictions based on the plurality of multi-task prompts and the plurality of spatial temporal embeddings.

11. The computer system of claim 10, wherein generating the plurality of multi-task prompts is performed using a cross-task prompt network.

12. The computer system of claim 11, wherein the cross-task prompt network receives support embeddings and a set of learnable queries as input and generates refined task-specific prompts through a series of transformer layers, a cross-task attention module, and fully connected layers.

13. The computer system of claim 12, wherein the series of transformer layers comprises a multi-head attention mechanism, a first add and normalize operation, a feed-forward network, and a second add and normalize operation.

14. The computer system of claim 10, wherein generating the plurality of multi-task prompts is performed using a prompt refinement decoder head.

15. The computer system of claim 10, wherein generating the plurality of multi-task prompts is performed using a cross-task prompt network and a prompt refinement decoder head.

16. The computer system of claim 10, wherein the multi-task frame predictions comprise refined segmentation prompts, refined phase prompts, and refined tule prompts.

17. The computer system of claim 10, wherein generating the multi-task frame predictions comprises prepending the plurality of multi-task prompts with patch embeddings of a key frame image to extract the plurality of spatial temporal embeddings.

18. The computer system of claim 10, wherein each of the plurality of multi-task prompts are formatted as a vector [B, Nₜₐₛₖ, Nₚᵣₒₘₚₜₛ, d], where B is a batch size, Nₜₐₛₖ is a number of tasks, Nₚᵣₒₘₚₜₛ is a number of prompts per task, and d is dimensionality of the vector.

19. A computer program product comprising:
one or more computer-readable storage media; and
program instructions stored on the one or more computer-readable storage media to perform operations for generating multi-task frame predictions for a current frame of a video of a surgical procedure, the operations comprising:
receiving historical video frames;
generating a plurality of multi-task prompts based on the historical video frames;
generating a plurality of spatial temporal embeddings based on the historical video frames and a current video frame; and
generating the multi-task frame predictions based on the plurality of multi-task prompts and the plurality of spatial temporal embeddings.

20. The computer program product of claim 19, wherein generating the plurality of multi-task prompts is performed using a cross-task prompt network, wherein the cross-task prompt network receives support embeddings and a set of learnable queries as input and generates refined task-specific prompts through a series of transformer layers, a cross-task attention module, and fully connected layers, and wherein the series of transformer layers comprises a multi-head attention mechanism, a first add and normalize operation, a feed-forward network, and a second add and normalize operation.
